(19) United States
(12) Patent Application Publication
(10) Pub. No.: US 2024/0400303 A1
(43) Pub. Date: Dec. 5, 2024

(54) A CONTAINER BUFFERING ASSEMBLY, A STORAGE SYSTEM COMPRISING THE CONTAINER BUFFERING ASSEMBLY, AND ASSOCIATED METHODS

(71) Applicant: Autostore Technology AS, Nedre Vats (NO)

(72) Inventor: Jørgen Djuve Heggebø, Langhus (NO)

(73) Assignee: Autostore Technology AS, Nedre Vats (NO)

(21) Appl. No.: 18/691,341

(22) PCT Filed: Sep. 13, 2022
(86) PCT No.: PCT/EP2022/075370

§ 371 Date: Mar. 12, 2024

(30) Foreign Application Priority Data
Sep. 17, 2021 (NO) 20211118

(51) Int. Cl. B65G 1/04; B65G 1/06

(52) U.S. Cl. CPC B65G 1/0464; B65G 1/0478; B65G 1/065

(57) ABSTRACT

A storage system includes a framework structure in which storage containers are stored, a container lift device, and a conveyor. The framework structure includes at least a first port column through which a storage container may be transferred by the container lift device. The first port column includes an upper end at which the container lift device is arranged when a storage container is to be lowered or lifted through the port column, and a lower end at which a container buffering assembly is arranged. The container buffering assembly includes a container holder frame including a plurality of supports. The container holder frame is movable in a first horizontal direction between a first position under the lower end of the first port column and a second position away from the lower end of the first port column. The supports are actuatable between: a holding position, in which the supports are configured to support a storage container; and a release position, in which a storage container may pass through the container holder frame. At least a part of the container holder frame is vertically movable for transferring a storage container between the container holder frame and the conveyor.

### FIELD OF THE INVENTION

The present invention relates to a storage system comprising a container buffering assembly for transferring storage containers between a container lift device and a conveyor, as well as a container buffering assembly. It is further described associated methods of transferring a storage container from a container lift device to a conveyor, as well as from a conveyor to a container lift device.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown. The lifting device may further comprise a lifting frame 27 suspended from lifting bands 25. The lifting bands 25 may provide power and communication between the container handling vehicle and the lifting frame 27. The lifting frame 27 may comprise gripping engaging devices 26 for connection to gripping recesses of a storage container 106.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

A storage system may also use port columns 119,120 to transfer a storage container between the rail system 108 on top of the framework structure 100 and a container transfer vehicle arranged below a lower end of the port column. Such storage systems and suitable container transfer vehicles are disclosed in WO 2019/238694 A1 and WO 2019/238697 A1, the contents of which are incorporated herein by reference.

A potential disadvantage of using a container transfer vehicle to retrieve and deliver storage containers from/to the lower end of a port column is the time dependency between the container transfer vehicle(s) and the container handling vehicles used to retrieve/deliver the storage containers through the port column.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting 20 device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

One objective of the invention is to solve at least some of the drawbacks related to prior art solutions.

In particular, one of the objectives of the invention is to reduce the time a storage container is held by a container lift device.

### SUMMARY OF THE INVENTION

The present invention is set forth and characterized in the independent claims, while the dependent claims describe other characteristics of the invention.

It is described a storage system comprising a framework structure in which storage containers are stored, a container lift device, and a conveyor, the framework structure comprises at least a first port column through which a storage container may be transferred by the container lift device,
the first port column comprises an upper end at which the container lift device is arranged when a storage container is to be lowered or lifted through the port column, and a lower end at which a container buffering assembly is arranged, the container buffering assembly comprises a container holder frame comprising a plurality of supports connected to the container holder frame;
the container holder frame is movable in a first horizontal direction X between a first position under the lower end of the first port column and a second position away from the lower end of the first port column;
the supports are actuatable between:
   a holding position, in which the supports are configured to support a storage container;
   a release position, in which a storage container may pass through the container holder frame;
and wherein at least a part of the container holder frame is vertically movable for transferring a storage container between the container holder frame and the conveyor.

The container holder frame may comprise two opposite sides, and at least one support is arranged at each of the two opposite sides. The supports may be any element suitable for holding a storage container at a fixed level relative to the container holder frame and is preferably divided into first and second sets of supports. The supports may for instance be pivotable or linear, rotatable half discs or horizontally moveable clamps, that may be actuated between a release position in which a storage container may pass through the container holder frame in a vertical direction and a holding position in which the supports will hold a storage container at a fixed level relative to the container holder frame. Actuation of the supports may be performed by any suitable type of electric, hydraulic or pneumatic actuator. The supports may be a fixed or integral part of the container holder frame and may for instance be actuated by contracting and/or extending an inner periphery of the container holder frame.

The term “port column” is intended to mean any port or opening through which a storage container may be transferred in a vertical direction. The lower end of the at least first port column may thus be directly below the upper end of the port column or at a distance from the upper end of the port column equal to one, two or more storage positions. When in the first position, the container holder frame may be defined as being directly or straight below the lower end of the first port column.

The framework structure may comprise vertical column profiles which define the at least first port column.

In the present specification the term “storage container” is intended to mean any goods holder unit having a bottom plate and side portions suitable for releasable connection to the container lift device, e.g. a bin, a tote, a tray or similar. The side portions may preferably comprise gripping recesses. The side portions are preferably sidewalls. The height of the sidewalls may vary depending on the intended use of the storage system and the goods to be stored. The gripping recesses may be arranged at an upper rim of the sidewalls. The outer horizontal periphery of the storage container is preferably rectangular.

In the first position, the container holder frame may be lowered to receive or deliver a storage container from/to the conveyor positioned under the container holder frame, may receive or deliver a storage container from/to the container lift device via the first port column and may allow passage of a storage container lifted/lowered by the container lift device through the container holder frame.

When in the second position, the container holder frame does not overlap with the lower end of the first port column. In other words, when in the second position the container holder frame does not extend under the lower end of the first port column. When in the second position, the container holder frame may be horizontally removed from the lower end of the first port column, such that the container lift device may transfer a storage container directly to a container transfer device arranged below the first port column without passing through the container holder frame.

In one aspect, the part of the container holder frame which is vertically movable is the container holder frame itself. The container holder frame may be vertically movable relative to the level of the lower end of the first port column, such that a storage container may be transferred between the container holder frame and the conveyor, i.e. such that the container holder frame may transfer a storage container from the lower end of the first port column to the container transfer device and from the conveyor to the lower end of the first port column.

In another aspect, the part of the container holder frame which is vertically movable is the supports. The supports may then be vertically movable between a lower position, in which a storage container is transferable between the supports and the conveyor, and an upper position, in which the conveyor may move below a storage container held by the supports.

The container lift device may be (or may be provided by) a movable container handling vehicle or a fixed container lift device as disclosed in WO 2020/210558 A1.

The conveyor can be a conveyor line. The conveyor or conveyor line can be formed as a continuous surface or may be rollers on which storage containers move.

The container holder frame may be vertically movable between a lower position, in which a storage container is transferable between the container holder frame and the conveyor, and an upper position, in which the conveyor may move below a storage container held by the container holder frame.

The container holder frame may comprise an opening for vertical throughput of storage containers therethrough.

The supports, i.e. the first and second set of supports, may be arranged along a periphery of the opening.

The first port column may be defined by four vertical column profiles and each vertical column profile may have a centre point and the centre points may define corners of a rectangular boundary line, and an outer periphery of the container holder frame may be equal to or smaller than the boundary line.

The container holder frame may be configured to move between the first position and the second position in a linear movement.

The container buffering assembly may comprise a shuttle to which the container holder frame is connected, and the shuttle may be arranged to move the container holder frame between the first position and the second position.

Another way of suspending the shuttle is described in US 2008/213073 A1 which is incorporated herein by reference.

The shuttle may have an inner periphery configured to allow passage of a storage container in a vertical direction.

The container buffering assembly may comprise rails connected to the lower end of the first port column, and the shuttle may be movably connected to the rails such that the container holder frame may move in the horizontal direction between the first position and the second position along the rails. Preferably, the rails extend parallel to the conveyor and allow the shuttle to move in the X direction. The rails also have a second function of providing support to the upright members above (they act like lintels) which in turn support the grid-based rail system above

The shuttle may comprise profiles for connection to rails arranged at the lower ends of the port columns as well as suitable means for moving the shuttle along the rails, e.g. via roller screw connection or other linear moving means.

The container holder frame may be vertically movable relative to the shuttle, i.e. between the lower position and the upper position. In the second position, when arranged below the lower end of the second port column, the container holder frame may be lowered to receive or deliver a storage container from/to a conveyor, may receive or deliver a storage container from/to the container lift device and may allow passage of a storage container lifted/lowered by the container lift device therethrough.

The framework structure may comprise a second port column, and the second position may be under a lower end of the second port column, i.e. the second position may be directly below or within a vertical projection of the second port columns.

In an aspect of the storage system, movements of the container holder frame and the conveyor may be synchronized.

The container holder frame may have an inner periphery configured to allow passage of a storage container in a vertical direction when the supports are retracted in the release position.

The storage system may comprise an additional container holder frame.

The container lift device may comprise a lifting assembly which is suspended from one or more spoolable lifting elements and arranged to be raised or lowered in order to raise or lower a releasably attached storage container within the port column.

The plurality of supports may be individually actuatable.

Preferably, some of the supports in the plurality of supports forms part of at least a first set of supports and some others of the supports form part of a second set of supports, and the supports of the first set of supports may be actuatable independently from the supports of the second set of supports.

The container holder frame may be configured to move horizontally in a second direction which is perpendicular to the first direction. One way of achieving this is to provide an upper shuttle and a lower shuttle where the container holder frame is connected to the lower shuttle. The upper shuttle can then be connected to the rails and allow movement in the X direction (i.e. in the travel direction of the conveyor) and the lower shuttle can be suspended from the upper shuttle and can be allowed to move relative to the upper shuttle.

The framework structure may comprise an upper rail system, and the container lift device can be a container handling vehicle comprising at least one set of wheels for moving the container handling vehicle in a horizontal direction on the upper rail system. The at least one set of wheels may be suitable for moving the container handling vehicle in two perpendicular horizontal directions on the upper rail system.

The upper rail system may comprise a vertical opening defining at least an upper part of the first port column. In some embodiments, the first port column may be an opening in the upper rail system. The opening allowing vertical transfer of a storage container from a topside of the upper rail system to a position below the upper rail system.

The storage system may further comprise a delivery rail system adjacent, next to or at the conveyor, and at least one delivery vehicle may operate on the delivery rail system, and the delivery vehicle can be configured to receive storage containers from above and/or from a side, and wherein the container buffering assembly can be configured to transfer a storage container between the delivery vehicle and the conveyor and/or between the delivery vehicle and the container lift device. The delivery vehicle may in this embodiment comprise a vehicle body, first set of wheels for driving in a first direction X on the delivery rail system and a second set of wheels for driving in a second direction Y on the delivery rail system.

Alternatively, the storage system may comprise a floor adjacent, next to or at the conveyor, and at least one delivery vehicle may operate on the floor, and the delivery vehicle can be configured to receive storage containers from above and/or from a side, and wherein the container buffering assembly can be configured to transfer a storage container between the delivery vehicle and the conveyor and/or between the delivery vehicle and the container lift device. The delivery vehicle may in this embodiment be a container transfer device freely movable on a floor (as disclosed in WO 2019/238697 A1).

Regardless whether a delivery rail system or a floor is arranged adjacent the conveyor, an upper surface of the delivery vehicle is preferably at the same height as the top surface of the conveyor in order to simplify the design of the container buffering assembly.

It is further described a container buffering assembly for transferring a storage container between a lower end of a port column and a conveyor, and wherein the container buffering assembly comprises:
rails connectable to the lower end of the port column;
a container holder frame connectable to the rails and comprising a plurality of supports;
the container holder frame is horizontally movable in a first direction X between a first position under the lower end of the first port column and a second position away from the lower end of the first port column; wherein the supports are actuatable between:
a holding position, in which the supports are configured to support a storage container;
a release position, in which a storage container may pass through the container holder frame;
and wherein at least a part of the container holder frame is vertically movable for transferring a storage container between the container holder frame and the conveyor.

Similar or equivalent as described in connection to the storage system above, in one aspect the container holder frame itself may be vertically movable and in another aspect the part of the container holder frame which is vertically movable is the supports.

The container buffering assembly may further comprise a shuttle comprising profiles movably connectable to the rails and the container holder frame may be connected to the shuttle. In this aspect, the shuttle and the container holder frame are horizontally movable between the first position and the second position.

When the supports are in the release position, the storage container may pass through the container holder frame vertically.

The container buffering assembly may further comprise vertical supports which form the port columns and/or which support the lower ends of the port columns. The vertical supports may form part of the container buffering assembly. The vertical supports may support the upper rail system. The vertical supports may form four corners of the port column and function as a guide for lifting device/frame of the container lift device.

It is further described a method of transferring a storage container from a container lift device to a conveyor using the storage system as described above or the container buffering assembly as described above, wherein the method comprises the steps of:
lowering a storage container through the port column to the lower end of the port column using a lifting device of the container lift device;
transferring the storage container from the container lift device to the container holder frame by lowering a lifting device of the container lift device with the storage container partially through the container holder frame while the supports are in the release position;
moving the supports to the holding position thereby supporting the storage container;
disconnecting the storage container from the lifting device of the container lift device;
lifting the lifting device away from the container holder frame;
lowering the container holder frame towards the conveyor;
moving the supports to the release position, thereby placing the storage container onto the conveyor.

It is further described a method of transferring a storage container from a container lift device to a conveyor using the storage system as described above or the container buffering assembly as described above, wherein the method comprises the steps of:
lowering a storage container through the port column to the lower end of the port column using a lifting device of the container lift device;
transferring the storage container from the container lift device to the container holder frame by lowering the container lift device with the storage container partially through the container holder frame while the supports are in the release position;
moving the supports to the holding position thereby supporting the storage container;
disconnecting the storage container from the lifting device of the container lift device;
lifting the lifting device away from the container holder frame;
lowering the supports towards the conveyor;
moving the supports to the release position, thereby placing the storage container onto the conveyor.

It is further described a method of transferring a storage container from a conveyor to a container lift device using the storage system as defined above or the container buffering assembly as defined above, wherein the method comprises the steps of:
lowering the container holder frame towards the conveyor into contact with a storage container on the conveyor and moving the supports to the holding position, thereby supporting the storage container;
lifting and horizontally moving the container holder frame to a position at the lower end of the port column;
lowering a lifting device of the container lift device through the port column into contact with the storage container and connecting the lifting device to the storage container;
moving the supports to the release position;
lifting the storage container through the container holder frame and the first port column to the container lift device.

In an aspect of the method, the plurality of supports may comprise at least a first set of supports and a second set of supports, and the first set of supports may be arranged in front of the second set of supports, and the first and second set of supports may be individually actuatable, and the step of lowering the container holder frame towards the conveyor into contact with a storage container may comprise the steps of:
actuating the first set of supports and reducing speed of the shuttle relative to speed of the conveyor thereby bringing the first set of supports into connection with the storage container;
when the first set of supports is connected to the storage container, actuating the second set of supports, thereby the container holder frame assumes control of the storage container and the storage container can be retrieved or lifted off the conveyor.

It is further described a method of transferring a storage container from a conveyor to a container lift device using the storage system as described above or the container buffering assembly as described above, wherein the method comprises the steps of:
lowering the supports towards the conveyor into contact with a storage container on the conveyor and moving the supports to the holding position, thereby supporting the storage container;
lifting the supports and horizontally moving the container holder frame to a position at the lower end of the port column;
lowering a lifting device of the container lift device through the port column into contact with the storage container and connecting the lifting device to the storage container;
moving the supports to the release position;
lifting the storage container through the container holder frame and the first port column to the container lift device.

The first set of supports may be a first set of linear supports or a first set of pivotable supports. Similarly, the second set of supports may be a second set of linear supports or a second set of pivotable supports.

The proposed container buffering assembly provides an interface between a storage part of a storage system and an external conveyor system. One of the challenges is to engage/disengage the storage container with a continuously moving surface. The proposed solution comprises a bin buffer which is allowed to move in both a horizontal and vertical direction, so it will move along with the conveyor when in the engage/disengage operation. The bin buffer positions will also work as temporary buffers between the storage part of the storage system and the conveyor system, which release potential dependency between the modules.

The storage system, container buffering assembly and methods may be used in connection with storage containers as described above. However, other areas where the disclosed storage system, container buffering assembly and methods may be used is within vertical farming, micro-fulfilment or grocery/e-grocery.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a storage system with a first port column comprising a lower end, and where a container buffering assembly is arranged at the lower end;

FIG. 6 is a view of the storage system in FIG. 5 perpendicular to the travel direction of the conveyor showing more details of the container buffering assembly, including a first and second container holder frame;

FIG. 7 is an enlarged view of section A in FIG. 6;

FIG. 8 is a view of the storage system in FIG. 5 with supports of the container holder frame in the form of first and second set of linear supports, seen along the moving direction of the conveyor;

FIG. 9 is an enlarged view of section B in FIG. 8;

FIG. 10A shows a container buffering assembly with an upper shuttle and a lower shuttle, and wherein the container holder frame is connected to the lower shuttle, where the container holder frame is movable in X and Y directions, and wherein the container holder frame is in lower position relative the lower shuttle;

FIG. 10B is a perspective view of the container buffering assembly in FIG. 10A;

FIG. 10C is another view of the container buffering assembly in FIG. 10A seen from a direction perpendicular to the view in FIG. 10A;

FIG. 11 is a perspective view of a container buffering assembly carrying a storage container, where a container holder frame of the container buffering assembly is movable in X direction and carries a storage container in a lower position;

FIG. 12 is another view of the container buffering assembly in FIG. 11 seen from a short end side of a storage container carried by the container buffering assembly;

FIG. 13 is a view of the container buffering assembly in FIGS. 10A-10C with a container holder frame movable in X and Y direction where supports in the form of a first set of linear supports are in a release position in which a storage container may pass through the container holder frame;

FIG. 14 a view of the container buffering assembly in FIGS. 10A-10C with a container holder frame movable in X and Y direction where supports in the form of a first set of linear supports are in a holding position, in which the first set of linear supports are configured to support the storage container arranged therebetween;

FIG. 15 is a top view of a possible synchronization between a container buffering assembly and a storage container moving on an underlying conveyor, where a first set of linear supports are in a holding position in which the first set of linear supports are configured to support a storage container and a second set of linear supports are in a release position in which a storage container may pass through the container holder frame;

FIG. 16 is a side view of a storage system with a container buffering assembly comprising two container holder frames, each of the container holder frames holding a storage container and where the container holder frame on the left hand has been lowered down towards the conveyor such that the storage container carried by the container holder frame is at or near the surface of the conveyor whereas the container holder frame on the right hand side has been lowered a relatively smaller distance such that the storage container carried by the container holder frame is at a distance from a surface of the conveyor;

FIG. 17 is side view of a storage system seen along the travel direction of a conveyor, where delivery vehicles configured to support a storage container from below is arranged to operate adjacent the conveyor and where the container holder frame of the container buffering assembly is configured to move horizontally in the X and Y directions along a moving direction of the conveyor as well as perpendicular to the first direction to transfer a storage container to and from the delivery vehicle;

FIG. 18 is a perspective view of a storage system like the one in FIG. 17 showing two delivery vehicles of different design adjacent the conveyor;

FIG. 19 is a perspective from the opposite side compared to FIG. 18;

FIG. 20 is top view of a port column along section A-A in FIG. 8 defined by four vertical column profiles and wherein each vertical column profile has a centre point and wherein the centre points define corners of a rectangular boundary line; and

FIG. 21 is a side perspective view of the container buffering assembly of FIGS. 10A-10C with a container holder frame 3a movable in a first and second direction between a conveyor 2 and a floor or rail system operating adjacent the conveyor 2;

FIGS. 22A-22C show a container holder frame with pivotable supports, where the pivotable supports are configured to lift a storage container vertically from an underlying conveyor;

FIG. 23 shows an example of a port column in the form of an opening in an upper rail system through which a storage container may be transferred in a vertical direction, and where the lower end of the port column is directly below the upper rail system;

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

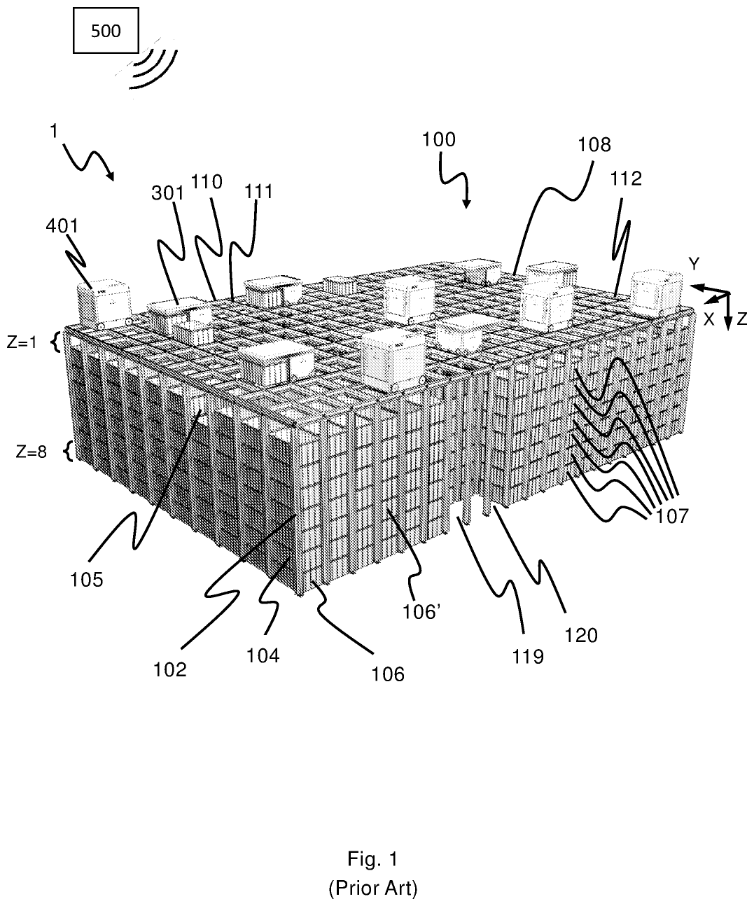

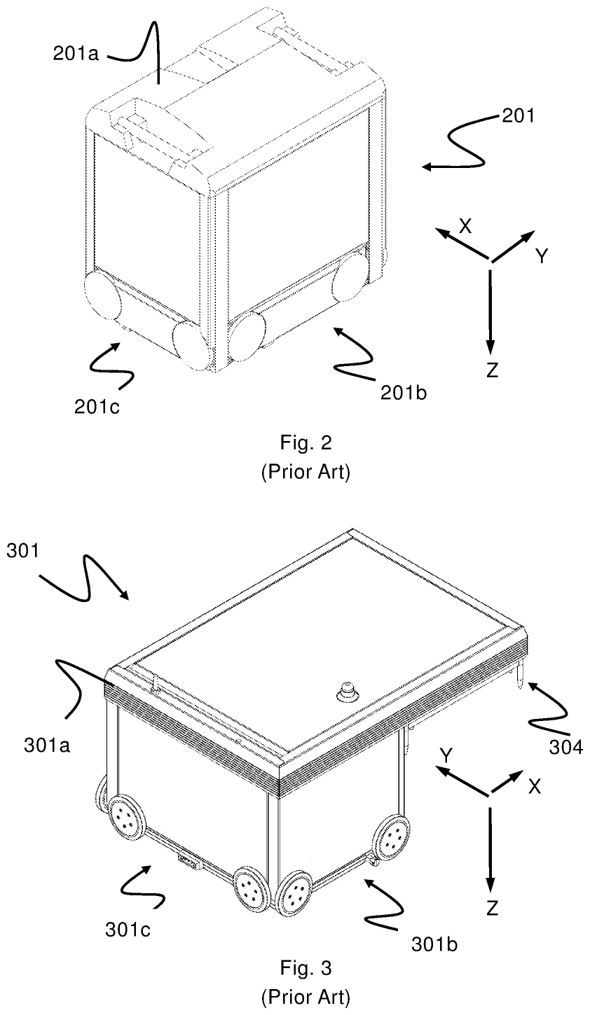

A framework structure 100 of the automated storage and retrieval system 1 may be constructed in a similar manner to the prior art framework structure 100 described above in connection with FIGS. 1-3. That is, the framework structure 100 may comprise a number of upright members 102, and comprise a first, upper rail system 108 extending in the X direction and Y direction.

The framework structure 100 may further comprise storage compartments in the form of storage columns 105 provided between the members 102 wherein storage containers 106 may be stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

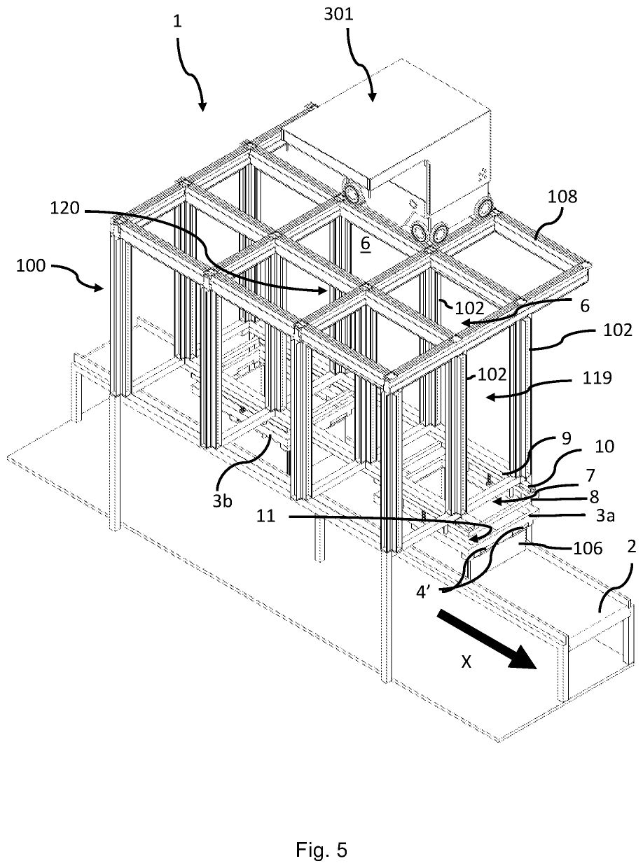

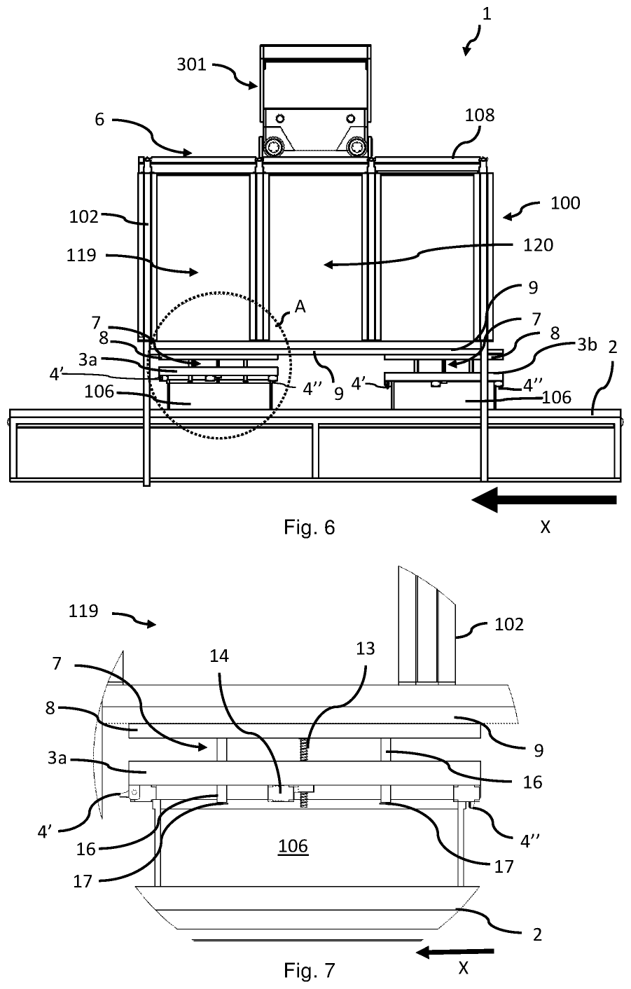

FIG. 5 is a perspective view of a storage system 1 with a first and second port column 119,120 comprising a lower end 7, and where a container buffering assembly is arranged at the lower end 7 of the port columns 119,120. A conveyor 2 (i.e. a conveyor line 2) is arranged below the lower end 7 of the first and second port columns 119,120 and extends in a horizontal direction. The storage system 1 comprises a framework structure 100. A container lift device 301 in the form of a cantilever container handling vehicle 301 operates on a rail system 108 (also referred to as upper rail system 108 herein) on top of the framework structure 100. The rail system 108 is arranged at an upper end 6 of the port columns 119,120. The framework structure 100 comprises vertical column profiles 102 defining the first and second port columns 119,120 through which a storage container 106 may be transferred by a lifting device (not shown in FIG. 6) of the cantilever container handling vehicle 301. The second port column 120 is shown next to the first port column 119. The port columns 119,120 are disclosed with an upper end 6 at which the cantilever container handling vehicle 301 is arranged and a lower end 7 at which the container buffering assembly is arranged. The container handling vehicle 301 can transfer a storage container 106 between the upper end 6 of the port columns 119,120 and the container buffering assembly arranged at the lower end of the port columns 119,120.

The disclosed container buffering assembly in FIGS. 5 and 6 features a first and second container holder frame 3a,3b. A first and second set of pivotable supports 4′,4″ are connected to the container holder frames 3a,3b. The container holder frames 3a,3b each comprise an opening 11 for vertical throughput of storage containers 106 therethrough. The supports in FIGS. 5 and 6 are provided as first and second sets of pivotable supports 4′,4″ which engage short end sides of the storage containers 106. The first and second set of supports 4′,4″ are arranged along a periphery of a through-going opening of the container holder frame 3a. The pivotable supports 4′,4″ are actuatable between a holding position, in which the supports 4 are configured to support a storage container 106, and a release position in which a storage container 106 may pass through the container holder frame 3a,3b.

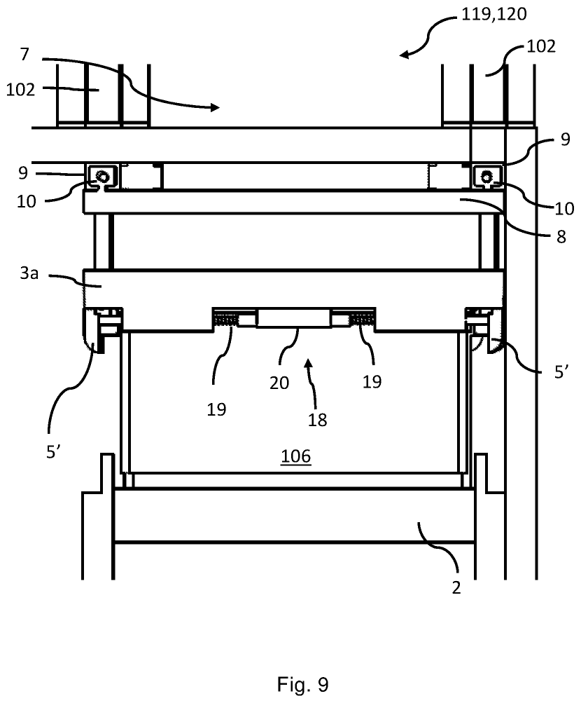

Both of the container holder frames 3a,3b are movable in a first horizontal direction X (as indicated by arrow X) between a first position under the lower end 7 of the respective port column 119,120 and a second position away from the lower end 7 of the first port column 119,120. The possibility of horizontal movement of the container holder frames 3a,3b eases transfer of a storage container 106 between the container holder frame 3a,3b and a moving conveyor 2 below. In order to be able to be horizontally movable, the container buffering assembly is disclosed with a shuttle 8 comprising profiles 10 (profiles 10 not shown in FIG. 6, see e.g. FIGS. 9-13) for connection to rails 9 at the lower end of the port columns 119,120.

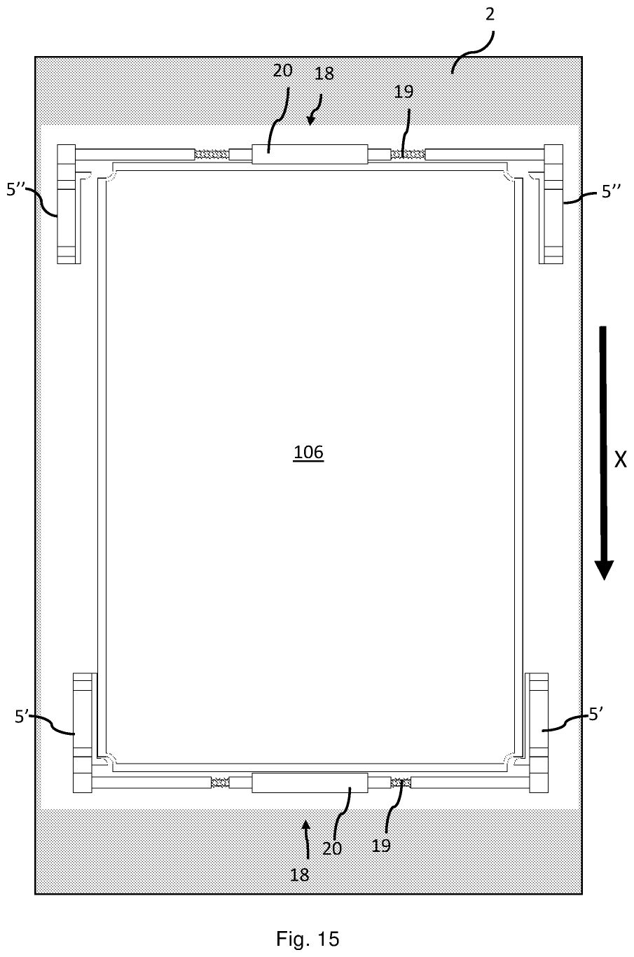

An example of synchronization between the container holder frame 3a,3b and a moving conveyor 2 is described in relation to FIG. 15 below.

FIG. 6 is a view of the storage system 1 in FIG. 5 perpendicular to the travel direction of the conveyor 2 showing more details of the container buffering assembly, including the first and second container holder frame 3a,3b and their position relative the underlying conveyor 2. As is seen in FIG. 6, the rails 9 of the container buffering assembly connected to the lower end of the port columns 119,120 extend in the travel direction of the conveyor 2. This renders possible that a shuttle 8 connected to the rails 9 via profiles 10 may move in the direction of travel (i.e. in the X direction as indicated by the arrow).

The container holder frame 3a (i.e. the one on the left hand side in FIG. 6) is in a lower position and about to place a storage container 106 onto the conveyor 2, i.e. in a release position of the container holder frame 3a. This is illustrated in FIG. 6 by the fact that a front end of the first set of pivotable supports 4′ (see details in FIG. 7) is in a position tilted away from the storage container 106 within the container holder frame 3a such that it is not capable of supporting a storage container 106 and the storage container 106 is allowed to be placed on the underlying conveyor 2.

Further referring to FIG. 6, the container holder frame 3b (i.e. the one on the right hand side in FIG. 6) is about to retrieve or pick up a storage container 106 from the conveyor 2. This is clear from the illustration since both the first set of pivotable supports 4′ at the front (i.e. on the left hand side) of the container holder frame 3a and the second set of pivotable supports 4″ at the rear (i.e. on the right hand side) of the container holder frame 3a are in the holding position, in which the first and second set of pivotable supports 4′,4″ support the storage container 106. The relative positions of the first and second sets of pivotable supports 4′,4″ are better illustrated in FIG. 7. The first and second set of pivotable supports 4′,4″ may be operable by a supports motor, a support actuator or similar (not shown) capable of moving the respective first and second set of pivotable supports between the holding position and the release position.

FIG. 7 is an enlarged view of section A in FIG. 6 showing details of components of the container buffering assembly. The first set of pivotable supports 4′ are in the container holder frame 3a is in a position tilted away from the storage container 106 within the container holder frame 3a such that it is not capable of supporting a storage container 106 and the storage container 106 is allowed to be placed on the underlying conveyor 2. The second set of pivotable supports 4″ are in the holding position.

The container buffering assembly may comprise a shuttle 8 to which the container holder frame 3a,3b is connected. The shuttle 8 may be arranged to move the container holder frame 3a,3b between the first position and the second position. Furthermore, the container buffering assembly may comprise rails 9 connected to the lower end 7 of the first and second port columns 119,120. The shuttle 8 may comprise profiles 10 such that the shuttle 8 can be movably connected to the rails 9 via the profiles 10. This setup renders possible that the container holder frame 3a,3b may move in the horizontal direction between the first position and the second position along the rails 9.

As further illustrated in FIG. 7, an example mechanism of vertically moving the container holder frame 3a for transferring the storage container 106 between the container holder frame 3a and the conveyor 2 is illustrated. The lifting and lowering mechanism of the container buffering assembly is illustrated with a vertical moving device 13 for moving the container holder frame 3a relative to the shuttle 8 and thus the lower end of the port column 119. The vertical moving device 13 may be a roller screw or similar mechanism enabling linear movement of the container holder frame 3a relative to a shuttle 8 to which it is movably connected. A motor 14 may operate the vertical moving device 13 to move the container holder frame 3a relative to the shuttle 8. One or more vertical guides 16 may extend from a lower end of the shuttle 8 and down through the goods or material of the container holder frame 3a such as to ensure substantially linear movement of the container holder frame 3a. One or more of the vertical guides 16 may comprise a stop, such as an end stop 17, to provide a maximum distance between the lower end of the shuttle 8 and the container holder frame 3a. The end stop 17 may be provided on one or more of the vertical guides 16 and may be formed by collar or similar with increased diameter such that it has a larger diameter than a through-going hole of the container holder frame 3a through which the vertical guides 16 extend.

An exemplary method of transferring a storage container 106 from the conveyor 2 to a container lift device 301 in order to retrieve or pick up a bin from a moving conveyor 2 with reference to FIGS. 5-7, may include:
lowering the container holder frame 3a towards the conveyor 2 into contact with a storage container 106 on the conveyor 2;
actuating the first set of pivotable supports 4′ and reducing speed of the shuttle 8 relative to speed of the conveyor 2 thereby bringing the first set of pivotable supports 4′ into connection with the storage container 106;
when the first set of pivotable supports 4′ is connected to the storage container 106, actuating the second set of pivotable supports 4″ such that both the first and second set of pivotable supports 4′,4″ are in the holding position and the storage container 106 is supported by the container holder frame 3a;
lifting and horizontally moving the container holder frame 3a to a position at the lower end 7 of the port column 119,120;
lowering a lifting device 24 of the container lift device 301 through the port column 119 into contact with the storage container 106 and connecting the lifting device 24 to the storage container 106;
moving the first and second set of pivotable supports 4′,4″ to the release position;
lifting the storage container 106 through the container holder frame 3a and the first port column 119 to the container lift device 301.

The step of actuating the first set of pivotable supports 4′ and reducing speed of the shuttle 8 relative to speed of the conveyor 2 thereby bringing the first set of pivotable supports 4′ into connection with the storage container 106 results in that the first set of pivotable supports 4′ prevents the storage container 106 from travelling at the same speed as the conveyor 2 and provides for the possibility of aligning the storage container 106 correctly relative to the container holder frame 3a such that when the second set of pivotable supports 4″ are actuated, the storage container 106 is properly aligned relative to the container holder frame 3a and thus sufficiently aligned for the lifting device 24 of the container lift device 301 to retrieve the storage container 106 from the container holder frame 3a and up through the port column 119.

Similarly, an exemplary method of transferring a storage container 106 from the container lift device 301 to a conveyor 2 with reference to FIGS. 5-7 may include:
lowering a storage container 106 through the first port column 119 to the lower end 7 of the first port column 119) using a lifting device 24 of the container lift device 301;
transferring the storage container 106 from the container lift device 301 to the container holder frame 3a by lowering the container lift device 301 with the storage container 106 partially through the container holder frame 3a while the first and second set of supports 4′,4″ are in the release position;
moving the first and second set of pivotable supports 4′,4″ to the holding position thereby supporting the storage container 106;
disconnecting the storage container 106 from the lifting device 24 of the container lift device 301;
lifting the lifting device 24 away from the container holder frame 3a;
lowering the container holder frame 3a towards the conveyor 2;
moving the first and second set of pivotable supports 4′,4″ to the release position, thereby placing the storage container 106 onto the conveyor 2.

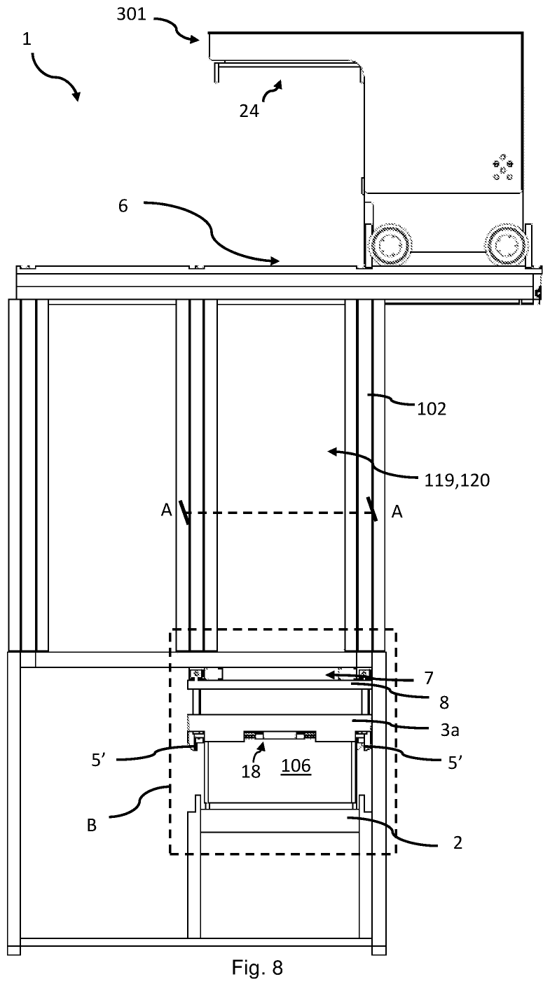

FIG. 8 is a view of the storage system 1 in FIG. 5 with supports of the container holder frame 3a in the form of first and second set of linear supports 5′,5′ (only the first set of linear supports is shown in FIG. 8), seen along the moving direction of the conveyor 2. The remaining components of the container buffering assembly are more or less identical to the components described with reference to FIGS. 5-7.

FIG. 9 is an enlarged view of section B in FIG. 8 and shows details of the buffering assembly connected at a lower end 7 of the port column 119,120. Rails 9 of the container buffering assembly are connected to the lower end of the port columns 119,120 and extend in the travel direction of the conveyor 2. This renders possible that the shuttle 8 connected to the rails 9 via profiles 10 on the shuttle 8 which extend in the same direction as the rails 9 may move in the direction of travel of the conveyor 2.

The supports in the disclosed first set of linear supports 5′ (but also valid for the second set of linear supports 5″) are movable between the holding position in which the supports 5′ of the first set of supports 5′ are configured to support a storage container 106 and the release position in which a storage container 106 may pass through the container holder frame 3a, upon operating an activation device 18.

The activation device 18 may operate all or some of the supports in the first set of linear supports 5′. The activation device 18 is disclosed with a roller screw 19 rotatably connected to a rotating device 20. The rotating device 20 may comprise a motor (not shown) for rotating the rotating device 20 and thus the roller screw 19. Similarly, the second set of linear supports 5″ may be operated by a similar activation device 18 (not shown). Although an activation device 18 with a roller screw 19 and rotating device 20 is disclosed, using other activation devices providing the same function of linear movement would also be possible.

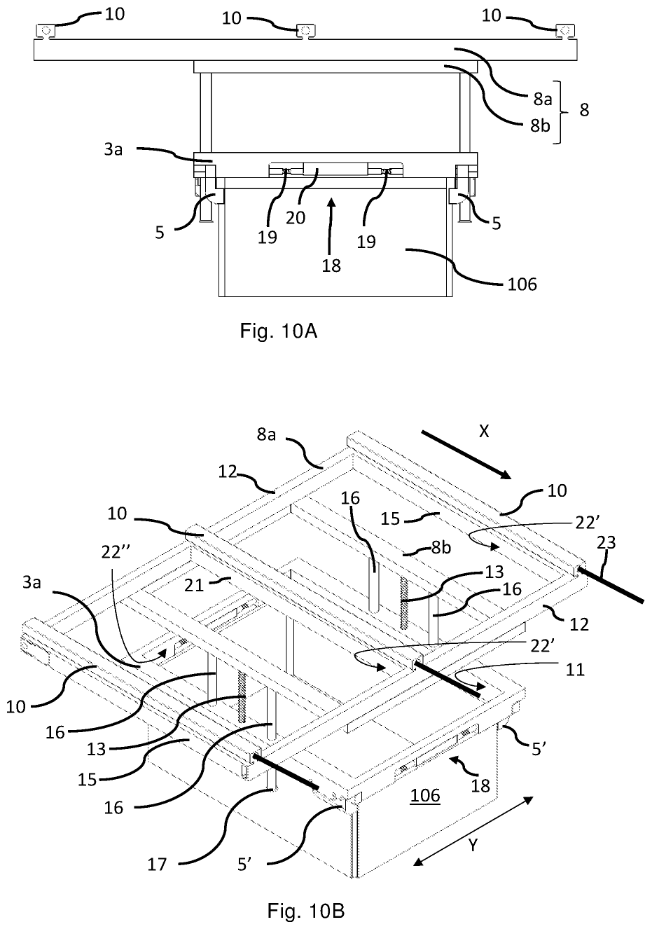

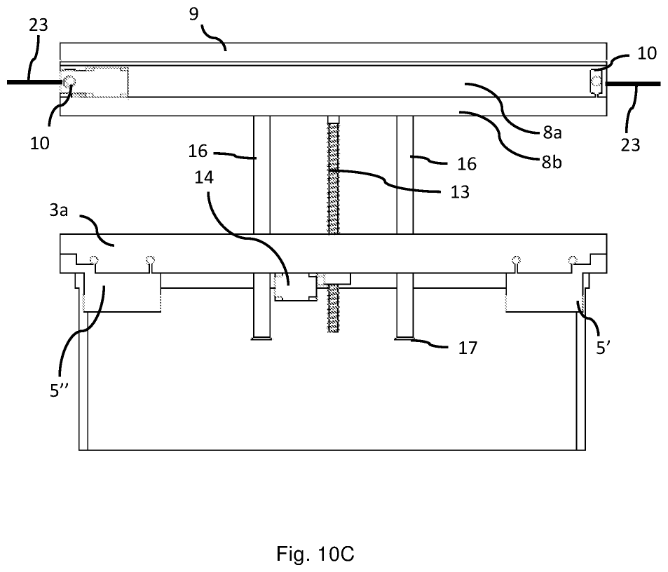

FIG. 10A shows a container buffering assembly with an upper shuttle 8a and a lower shuttle 8b, and wherein the container holder frame 3a is connected to the lower shuttle 8b, where the container holder frame 3a is movable in X and Y directions, and wherein the container holder frame 3a is in a lower position relative to the lower shuttle 8b.

FIG. 10B is a perspective view of the container buffering assembly in FIG. 10A. The container buffering assembly carrying a storage container 106, where a container holder frame 3a of the container buffering assembly is in a lower position. In FIG. 10B, the framework structure 100 and the conveyor have been omitted to better illustrate the components which may form part of the container buffering assembly. The shuttle 8 is divided in an upper shuttle 8a and a lower shuttle 8b. The upper shuttle 8a is connected to the rails and allows movement in the X direction (i.e. in the travel direction of the conveyor 2). The lower shuttle 8b is suspended from the upper shuttle 8a and is allowed to move relative to the upper shuttle 8a.

The upper shuttle 8a is disclosed with three parallel profiles 10 for connection to respective rails 9 on a lower end of port columns 119,120. A horizontal periphery of the upper shuttle 8a has a rectangular outer shape formed of a pair of parallel bars 15 extending in the direction of the profiles 10 and two cross members 12 connecting the parallel bars 15. A stiffening member 21 is arranged midway between the parallel bars 15 and separates an inner periphery of the upper shuttle 8a into two equally sized openings 22′. The horizontal periphery of the upper shuttle 8a in FIG. 10B is equal to or slightly smaller than two grid cells (i.e. access opening and half a rail width on each side), such that the upper shuttle 8a fits below two port columns 119,120 and may receive a storage container from both port columns 119,120 above through the openings 22′. The container holder frame 3a is connected to the lower shuttle 8b. The lower shuttle 8b has an opening 22″ of the same size as the openings 22′ of the upper shuttle 8a. The container holder frame 3a is disclosed with an opening 11 for vertical throughput of storage containers 106 therethrough. The opening 11 in the container holder frame 3a is preferably equal in size to the opening 22′,22″ of the inner periphery of the upper and lower shuttles 8a,8b.

FIG. 10C is another view of the container buffering assembly in FIG. 10A seen from a direction perpendicular to the view in FIG. 10A. FIG. 10C shows details of a vertical moving device 13, a motor 14 for operating vertical moving device, and vertical guides 16 with end stop 17 which render possible lowering and lifting of the container holder frame 3a relative to the upper shuttle 8a. An identical vertical movement mechanism has already been described in relation to FIG. 7 and will not be repeated herein. In addition, the function of the activation device 18 has been described in relation to FIG. 9 and will not be repeated herein.

Referring to FIGS. 10A-10C the horizontal movement of the upper shuttle 8a in the X direction, and consequently the container holder frame 3a, relative to the rails 9 is obtained by a drive assembly featuring a roller screw 23 and an electric motor (not shown in FIGS. 10A-10C). The horizontal movement in the X direction may alternatively be obtained by any suitable linear actuator or drive assembly featuring various types of screw drives, driven wheels/rails, rack/pinion and sprocket/chain. Further referring to FIGS. 10A-10C, horizontal movement of the lower shuttle 8b in the Y direction relative to the upper shuttle 8a may be obtained by a similar drive assembly featuring a roller screw 23 and an electric motor (not shown). The horizontal movement in the X direction may alternatively be obtained by any suitable linear actuator or drive assembly featuring various types of screw drives, driven wheels/rails, rack/pinion and sprocket/chain

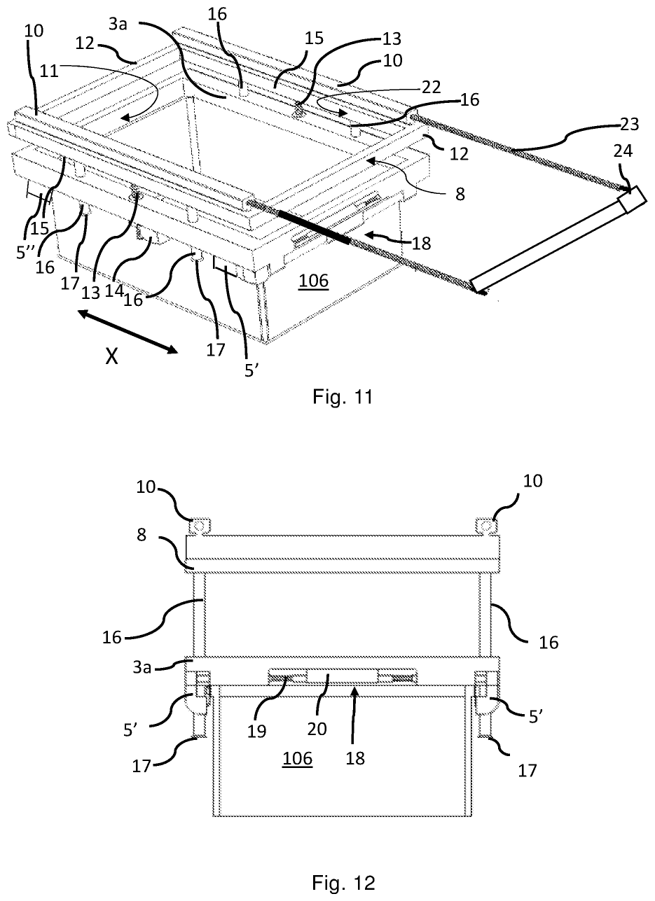

FIG. 11 is a perspective view of a container buffering assembly carrying a storage container 106, where a container holder frame 3a of the container buffering assembly is movable in an X direction and carries the storage container 106 in a lower position. In FIG. 11, the framework structure 100 and the conveyor have been omitted to better illustrate the components which may form part of the container buffering assembly. The shuttle is connected to the rails (not shown) via profiles 10 and allows movement in the X direction (i.e. in the travel direction of the conveyor 2). The horizontal movement of the shuttle 8 in the X direction, and consequently the container holder frame 3a which is connected to the shuttle 8, relative to the rails 9 is obtained by a drive assembly featuring a roller screw 23 and an electric motor 24. The horizontal movement may alternatively be obtained by any suitable linear actuator or drive assembly featuring various types of screw drives, driven wheels/rails, rack/pinion and sprocket/chain.

The shuttle 8 is disclosed with two parallel profiles 10 for connection to respective rails 9 on a lower end of port columns 119,120. A horizontal periphery of the shuttle 8 has a rectangular outer shape formed of a pair of parallel bars 15 extending in the direction of the profiles 10 and two cross members 12 connecting the parallel bars 15. The horizontal periphery of the shuttle 8 in FIG. 11 is equal to or slightly smaller than one grid cell, such that the shuttle 8 fits below one port column 119,120 and may receive a storage container from both port columns 119,120 above. The container holder frame 3a is connected to the shuttle 8. The container holder frame 3a is disclosed with an opening 11 for vertical throughput of storage containers 106 therethrough. The opening 11 in the container holder frame 3a is preferably equal in size to the opening 22′ of the inner periphery of the upper shuttle 8a. The function of the vertical movement mechanism has already been described in relation to FIG. 7 and will not be repeated herein.

FIG. 12 is another view of the container buffering assembly in FIG. 11 seen from a short end side of a storage container carried by the container buffering assembly and shows the mechanism for operating the first and second set of linear supports 5′,5″. The function of the activation device 18 with a roller screw 19 rotatably connected to a rotating device 20 has been described in relation to FIG. 9 and will not be repeated herein.

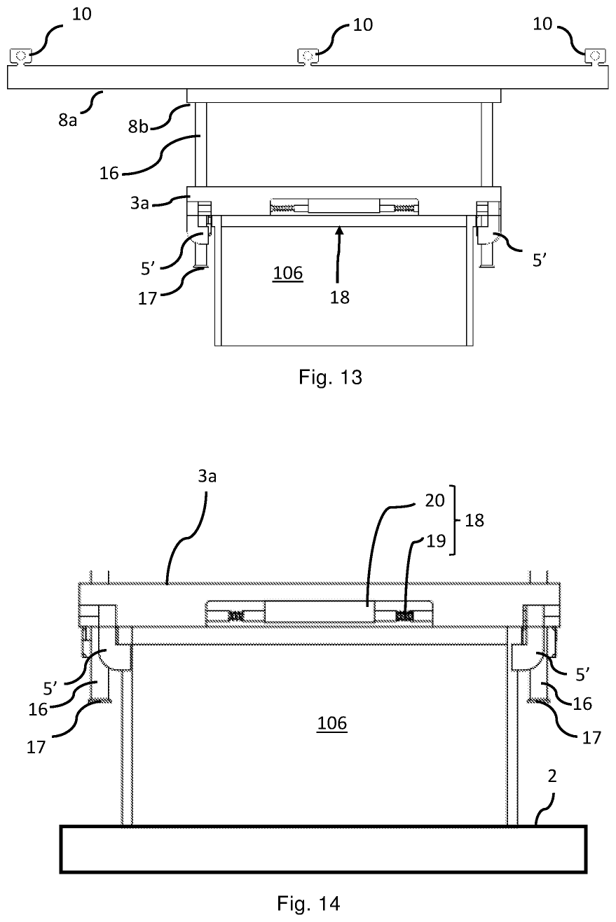

FIG. 13 is a view of the container buffering assembly in FIGS. 10A-10C with a container holder frame 3a movable in X and Y direction where supports in the form of a first set of linear supports 5′ are in a release position in which a storage container 106 may pass through the container holder frame 3a.

FIG. 14 is a view of the container buffering assembly in FIGS. 10A-10C with a container holder frame 3a movable in X and Y direction where supports in the form of a first set of linear supports 5′ are in a holding position, in which the first set of linear supports 5′ are configured to support the storage container 106 arranged therebetween. When comparing the relative positions of the first set of linear supports 5′,5″ in FIGS. 13 and 14, one can see that the first set of linear supports 5′,5″ in FIG. 14 is in contact with the storage container 106 in FIG. 14 whereas the first set of linear supports 5′,5″ in FIG. 13 is at a distance from the storage container 106.

FIG. 15 is a top view of a possible synchronization between a container buffering assembly and a storage container 106 moving on an underlying conveyor 2, where a first set of linear supports 5′ are in a holding position in which the first set of linear supports 5′ are configured to support a storage container 106 and a second set of linear supports 5″ are in a release position in which a storage container 106 may pass through the container holder frame.

An exemplary method of transferring a storage container 106 from the conveyor 2 to a container lift device 301 in order to retrieve or pick up a bin from a moving conveyor 2 with reference to FIGS. 8-15, may include:
lowering the container holder frame 3a towards the conveyor 2 into contact with a storage container 106 on the conveyor 2;
actuating the first set of linear supports 5′ and reducing speed of the shuttle 8/upper shuttle 8a relative to speed of the conveyor 2 thereby bringing the first set of linear supports 5′ into connection with the storage container 106;
when the first set of linear supports 5′ is connected to the storage container 106, actuating the second set of linear supports 5″ such that both the first and second set of linear supports 5′,5″ are in the holding position and the storage container 106 is supported by the container holder frame 3a;
lifting and horizontally moving the container holder frame 3a to a position at the lower end 7 of the port column 119,120;
lowering a lifting device 24 of the container lift device 301 through the port column 119 into contact with the storage container 106 and connecting the lifting device 24 to the storage container 106;
moving the first and second set of linear supports 5′,5″ to the release position;
lifting the storage container 106 through the container holder frame 3a and the first port column 119 to the container lift device 301.

The step of actuating the first set of linear supports 5′ and reducing speed of the shuttle 8/upper shuttle 8a relative to speed of the conveyor 2 thereby bringing the first set of pivotable supports 4′ into connection with the storage container 106 results in that the first set of linear supports 5′ prevents the storage container 106 from travelling at the same speed as the conveyor 2 and provides for the possibility of aligning the storage container 106 correctly relative to the container holder frame 3a such that when the second set of linear supports 5″ are actuated, the storage container 106 is properly aligned relative to the container holder frame 3a and thus sufficiently aligned for the lifting device 24 of the container lift device 301 to retrieve the storage container 106 from the container holder frame 3a and up through the port column 119.

Similarly, an exemplary method of transferring a storage container 106 from the container lift device 301 to a conveyor 2 with reference to FIGS. 8-15 may include:
lowering a storage container 106 through the first port column 119 to the lower end 7 of the first port column 119) using a lifting device 24 of the container lift device 301;
transferring the storage container 106 from the container lift device 301 to the container holder frame 3a by lowering the container lift device 301 with the storage container 106 partially through the container holder frame 3a while the first and second set of linear supports 5′,5″ are in the release position;
moving the first and second set of linear supports 5′,5″ to the holding position thereby supporting the storage container 106;
disconnecting the storage container 106 from the lifting device 24 of the container lift device 301;
lifting the lifting device 24 away from the container holder frame 3a;
lowering the container holder frame 3a towards the conveyor 2;
moving the first and second set of linear supports 5′,5″ to the release position, thereby placing the storage container 106 onto the conveyor 2.

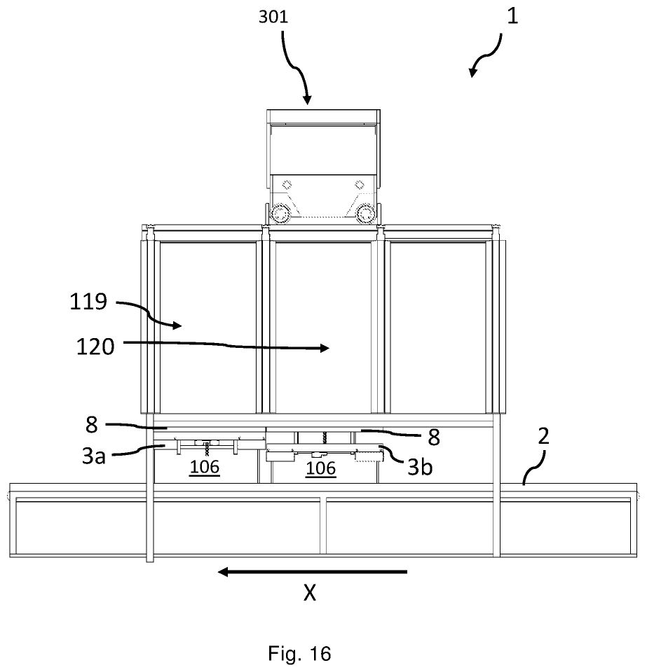

FIG. 16 is a side view of a storage system 1 with a container buffering assembly comprising two container holder frames 3a, each of the container holder frames 3a,3b holding a storage container 106 and where the container holder frame 3a on the left hand has been lowered down towards the conveyor 2 such that the storage container 106 carried by the container holder frame 3a is at or near the surface of the conveyor 3, whereas the container holder frame 3b on the right hand side has been lowered a relatively smaller distance such that the storage container carried 106 by the container holder frame 3b is at a distance from a surface of the conveyor 2.

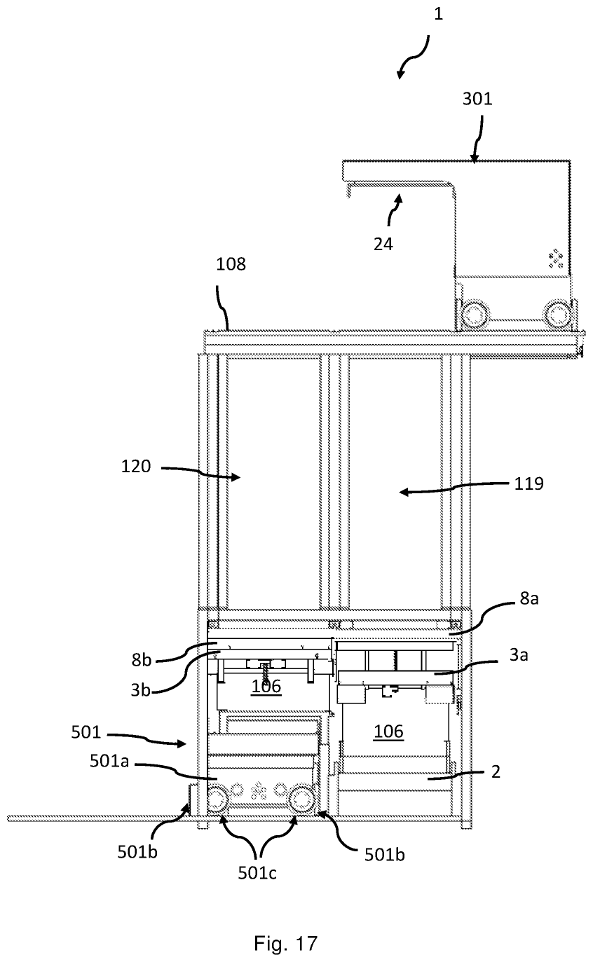

FIG. 17 is side view of a storage system 1 seen along the travel direction of a conveyor 2, where delivery vehicles 501 configured to support a storage container 106 from below is arranged to operate adjacent the conveyor 2 and where the container holder frame of the container buffering assembly is configured to move horizontally in a the X and Y directions along a moving direction of the conveyor as well as perpendicular to the first direction to transfer a storage container to and from the delivery vehicle. A container buffering assembly as exemplified in FIGS. 10A-10C may be used in order for the container holder devices 3a,3b to be able to move both in the X and Y directions.

The delivery vehicle 501 may be a remotely operated delivery vehicle 30 operable on a rail system (as disclosed e.g. in WO 2019/238645A1). The delivery vehicle 501 may comprise a vehicle body 501, first set of wheels 501b for driving in a first direction X and a second set of wheels 501c for driving in a second direction Y. The rail system for the delivery vehicle 501 may be of the same size and orientation as the upper rail system 108 where the container handling vehicles 301 operate. Alternatively, the delivery vehicle 501 may be a container transfer device 6 freely movable on a floor (as disclosed in WO 2019/238697 A1, reference numbers as used in said WO-publications).

An upper surface of the delivery vehicle 501 is preferably at the same height as the top surface of the conveyor 2 in order to simplify the design of the container buffering assembly.

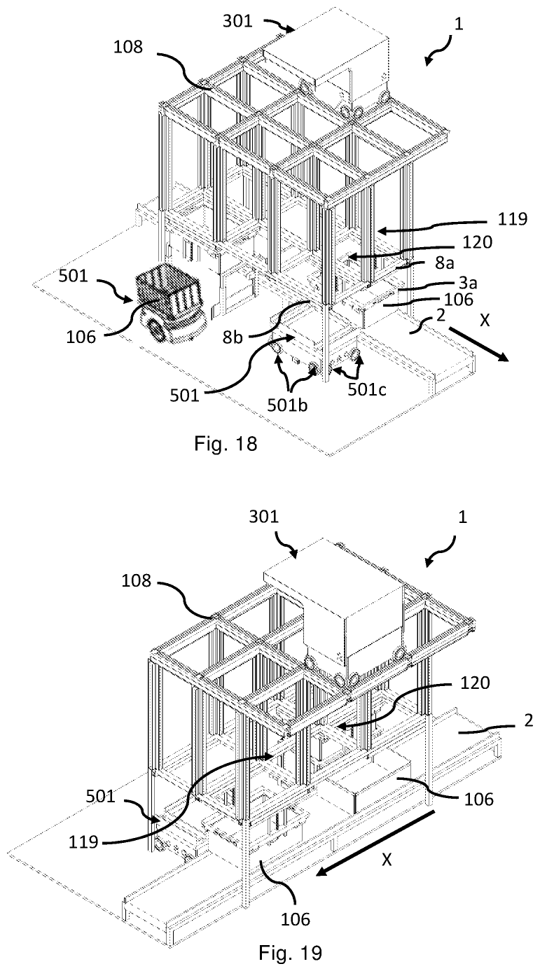

FIG. 18 is a perspective view of a storage system 1 like the one in FIG. 17 showing two delivery vehicles 501 of different design adjacent the conveyor 2.

FIG. 19 is a perspective from the opposite side compared to FIG. 18.

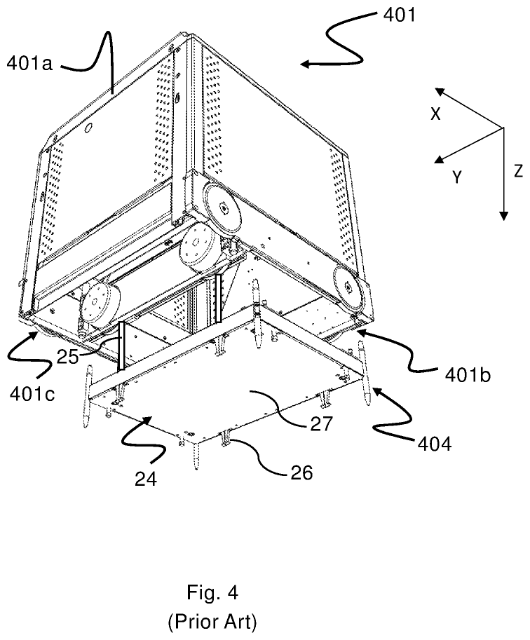

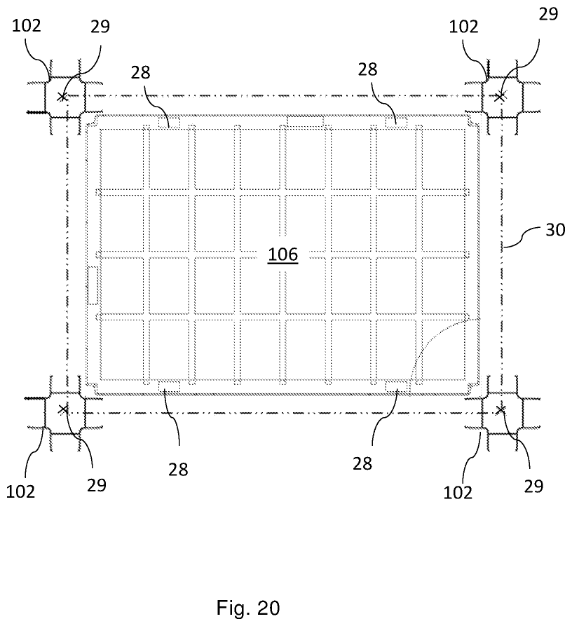

FIG. 20 is top view of a port column along section A-A in FIG. 8 defined by four vertical column profiles 102 and wherein each vertical column profile has a centre point 29 and wherein the centre points define corners of a rectangular boundary line 30. The port columns 119,120 are each defined by four of the vertical column profiles 102. The vertical column profiles have a centre point or line C defining the corners of a rectangular boundary line 30 and four corner sections 29 arranged to accommodate a corner of a storage container 106. The storage container 106 is disclosed with gripping recesses 28 for receiving the gripping engaging devices 26 (see. e.g. FIG. 4) of the lifting device. Adjacent port columns, such as the first port column 119 and the second port column 120 have one side of the boundary line in common. An outer periphery of a shuttle 8 and the corresponding container holder frame 3a,3b is preferably configured to fit within the boundary line 30. The size of the outer periphery of the shuttle 8 and the corresponding container holder frame 3a,3b allows the first container holder frame 3a and the second container holder frame 3b to be arranged simultaneously under two adjacent port columns, e.g. the first port column 119 and the second port column 120.

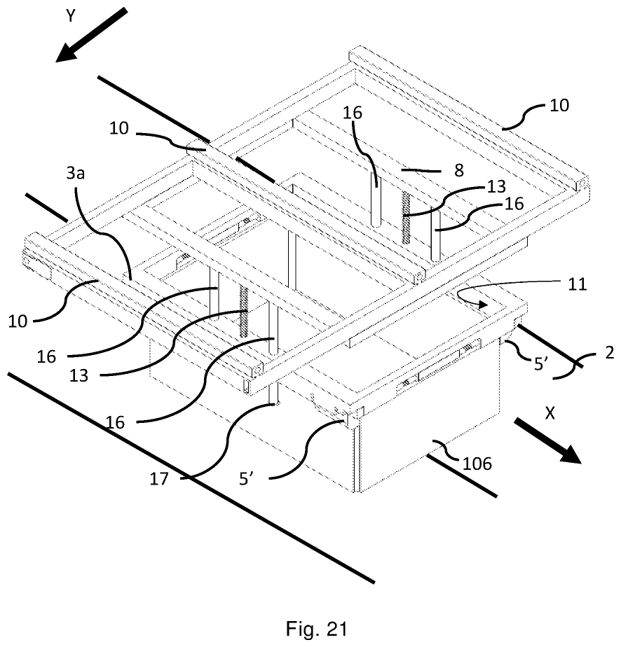

FIG. 21 is a side perspective view of the container buffering assembly of FIGS. 10A-10C with a container holder frame 3a movable in a first and second direction between a conveyor 2 and a floor or rail system operating adjacent the conveyor 2.

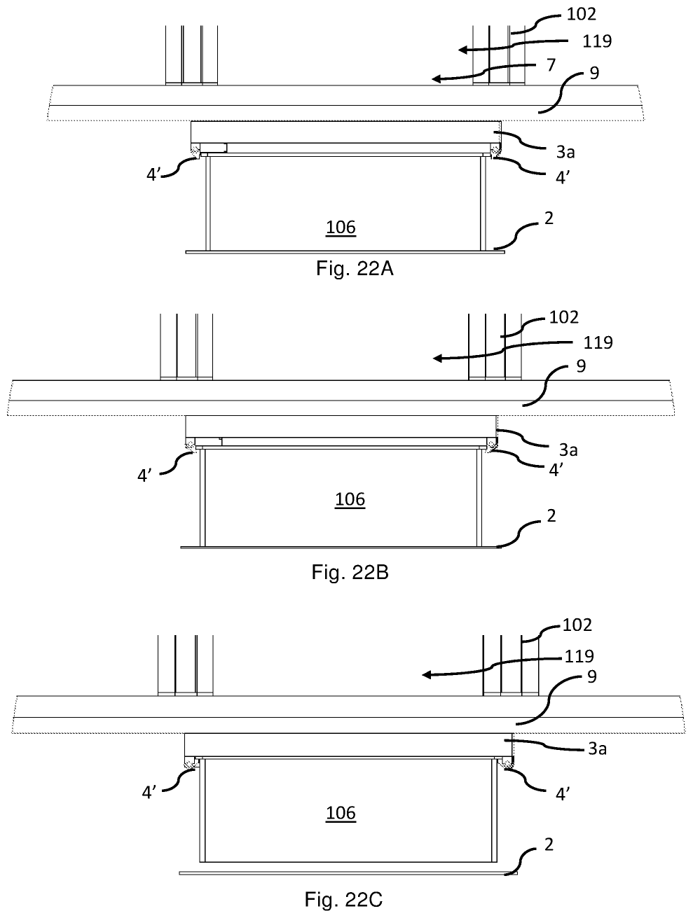

FIGS. 22A-22C show a container holder frame 3a with pivotable supports 4′, where the pivotable supports 4′ are configured to lift a storage container 106 vertically from an underlying conveyor 2. The container holder frame 3a is connected directly to the rails 9 at the lower end 7 of port column 119. When comparing the bottom part of the storage container 106 relative the conveyor 6, it can be seen that the distance is larger in FIG. 22C compared to FIGS. 22A and 22B. Furthermore, in FIG. 22A, the supports 4′ are directed downwards, whereas in FIG. 22B the supports 4′ are directed inclined towards the side of the storage container 106, whereas in FIG. 22C the supports 4′ are directed sideways and supports the storage container 106.

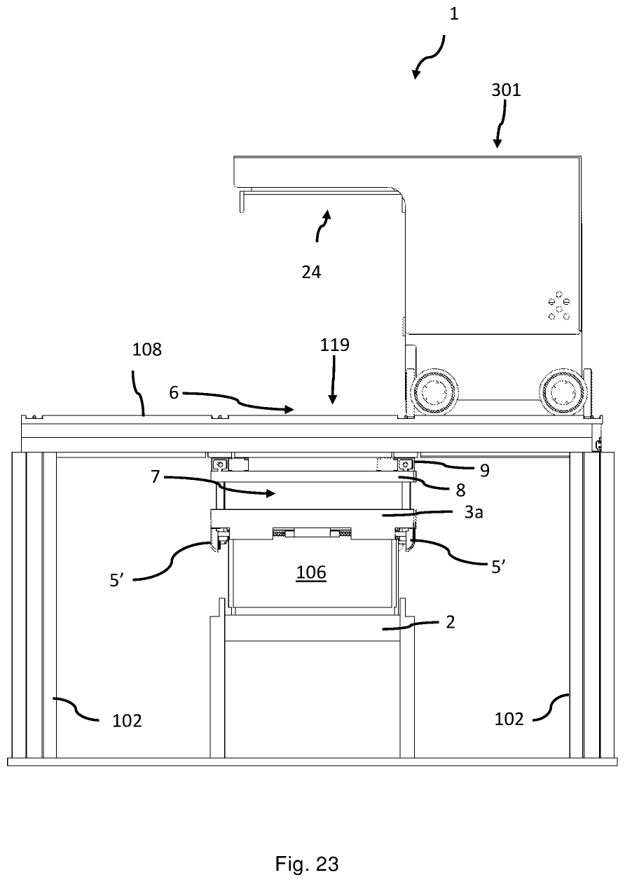

FIG. 23 shows an example of a port column in the form of an opening in an upper rail system 108 through which a storage container 106 may be transferred in a vertical direction, and where the lower end 7 of the port column 119 is directly below the upper rail system 108. The container holder frame 3a in FIG. 23 is identical to the one described in relation to e.g. FIG. 8 above. However, compared to FIG. 8, the first port column 119 in FIG. 23 is only defined by the opening in the upper rail system 108. This solution is suitable when the conveyor 2 may be arranged at a higher level than e.g. in FIG. 8 and provides the same advantages as described above.

The container buffering assembly may provide a highly advantageous functionality irrespective of whether the storage system comprises a mobile container lift device, i.e. a wheel-driven container handling vehicle 301,401, or a container lift device fixed at the upper end of the first port column. An exemplary storage system featuring a fixed container lift device in which the present invention would be highly advantageous is disclosed in WO 2020/210558 A1.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention. For example, the first and second set of pivotable supports 4′,4″ may be activated between the holding position and the release position using a similar activation device 18 as described in relation to activation of the first and second set of linear supports 5′,5″.

### LIST OF REFERENCE NUMBERS

| | |
|---|---|
| 1 | Prior art automated storage and retrieval system |
| 2 | Conveyor |
| 3a, 3b | Container holder frame |
| 4′ | Supports/First set of pivotable supports |
| 4″ | Supports/Second set of pivotable supports |
| 5′ | Supports/First set of linear supports |
| 5″ | Supports/Second set of linear supports |
| 6 | Upper end of port column |
| 7 | Lower end of port column |
| 8 | Shuttle |
| 8a | Upper shuttle |
| 8b | Lower shuttle |
| 9 | Rails |
| 10 | Profiles of shuttle |
| 11 | Opening container holder frame |
| 12 | Cross member |
| 13 | Vertical moving device |
| 14 | Motor for operating vertical moving device |
| 15 | Bars |
| 16 | Vertical guide |
| 17 | End stop of vertical guide |
| 18 | Activation device |
| 19 | Roller screw |
| 20 | Rotating device |
| 21 | Stiffening member |
| 22 | Opening shuttle |
| 22′ | Opening upper shuttle |
| 22″ | Opening lower shuttle |
| 23 | Linear movement device shuttle |
| 24 | Lifting device |
| 25 | Lifting bands |
| 26 | Gripping engaging device |
| 27 | Lifting frame |
| 28 | Gripping recess for gripping engaging device |
| 29 | Centre point |
| 30 | Boundary line |
| 100 | Framework structure |
| 102 | Upright members of framework structure |
| 104 | Storage grid |
| 105 | Storage column |
| 106 | Storage container |
| 106′ | Particular position of storage container |
| 107 | Stack |
| 108 | Rail system (upper) |
| 110 | Parallel rails in first direction (X) |
| 112 | Access opening |
| 119 | First port column |
| 120 | Second port column |
| 201 | Prior art container handling vehicle |
| 201a | Vehicle body of the container handling vehicle 201 |
| 201b | Drive means/wheel arrangement/first set of wheels in first |
| | direction (X) |
| 201c | Drive means/wheel arrangement/second set of wheels in second |
| | direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 501 | Prior art delivery vehicle |
| 501a | Vehicle body of the delivery vehicle 501 |
| 501b | Drive means/first set of wheels in first direction (X) |
| 501c | Drive means/second set of wheels in second direction (Y) |
| A | Section A |
| A-A | Section A-A |
| B | Section B |
| X | First direction |
| Y | Second direction |
| Z | Third direction |

1. A storage system comprising a framework structure in which storage containers are stored, a container lift device, and a conveyor, the framework structure comprises at least a first port column through which a storage container may be transferred by the container lift device, the first port column comprises an upper end at which the container lift device is arranged when a storage container is to be lowered or lifted through the port column, and a lower end at which a container buffering assembly is arranged, the container buffering assembly comprises a container holder frame comprising a plurality of supports;
the container holder frame is movable in a first horizontal direction between a first position under the lower end of the first port column and a second position away from the lower end of the first port column;
the supports are actuatable between:
a holding position, in which the supports are configured to support a storage container; and
a release position, in which a storage container may pass through the container holder frame;
wherein at least a part of the container holder frame is vertically movable for transferring a storage container between the container holder frame and the conveyor.

2. The storage system according to claim 1, wherein the container holder frame is vertically movable between a lower position, in which a storage container is transferable between the container holder frame and the conveyor, and an upper position, in which the conveyor may move below a storage container held by the container holder frame.

3. The storage system according to claim 1, wherein the supports are vertically movable between a lower position, in which a storage container is transferable between the supports and the conveyor, and an upper position, in which the conveyor may move below a storage container held by the supports.

4. The storage system according to claim 1, wherein the container holder frame comprises an opening for vertical throughput of storage containers therethrough.

5. The storage system according to claim 4, wherein the supports are arranged along a periphery of the opening.

6. The storage system according to claim 4, wherein the first port column is defined by four vertical column profiles and wherein each vertical column profile has a centre point and wherein the centre points define corners of a rectangular boundary line, and wherein an outer periphery of the container holder frame is equal to or smaller than the boundary line.

7. The storage system according to claim 1, wherein the container holder frame is configured to move between the first position and the second position in a linear movement.

8. The storage system according to claim 1, wherein the container buffering assembly comprises a shuttle to which the container holder frame is connected, wherein the shuttle is arranged to move the container holder frame between the first position and the second position.

9. The storage system according to claim 8, wherein the shuttle has an inner periphery configured to allow passage of a storage container in a vertical direction.

10. The storage system according to claim 8, wherein the container buffering assembly comprises rails connected to the lower end of the first port column, and the shuttle is movably connected to the rails such that the container holder frame may move in the horizontal direction between the first position and the second position along the rails.

11. The storage system according to claim 8, wherein the container holder frame is vertically movable relative to the shuttle.

12. The storage system according to claim 1, wherein the framework structure comprises a second port column, and the second position is under a lower end of the second port column.

13. The storage system according to claim 1, wherein movements of the container holder frame and the conveyor are synchronized.

14. The storage system according to claim 1, wherein the container holder frame has an inner periphery configured to allow passage of a storage container in a vertical direction when the supports are retracted in the release position.

15. The storage system according to claim 1, comprising an additional container holder frame.

16. The storage system according to claim 1, wherein the container lift device comprises a lifting assembly which is suspended from one or more spoolable lifting elements and arranged to be raised or lowered in order to raise or lower a releasably attached storage container within the port column.

17. The system according to claim 1, wherein the plurality of supports are individually actuatable.

18. The system according to claim 1, wherein some of the supports in the plurality of supports forms part of at least a first set of supports and some others of the supports form part of a second set of supports, wherein the supports of the first set of supports are actuatable independently from the supports of the second set of supports.

19. The storage system according to claim 1, wherein the container holder frame is configured to move horizontally in a second direction which is perpendicular to the first direction.

20. The storage system according to claim 1, wherein the framework structure comprises an upper rail system, and the container lift device is a container handling vehicle comprising at least one set of wheels for moving the container handling vehicle in a horizontal direction on the upper rail system.

21. The storage system according to claim 1, further comprising a delivery rail system adjacent the conveyor, wherein at least one delivery vehicle operates on the delivery rail system, and wherein the delivery vehicle is configured to receive storage containers from above and/or from a side, and wherein the container buffering assembly is configured to transfer a storage container between the delivery vehicle and the conveyor and/or between the delivery vehicle and the container lift device.

22. A container buffering assembly for transferring a storage container between a lower end of a port column and a conveyor, and wherein the container buffering assembly comprises:
rails connectable to the lower end of the port column;
a container holder frame connectable to the rails and comprising a plurality of supports;
the container holder frame is horizontally movable in a first direction between a first position under the lower end of the first port column and a second position away from the lower end of the first port column; wherein the supports are actuatable between:
a holding position, in which the supports are configured to support a storage container;
a release position, in which a storage container may pass through the container holder frame;
and wherein at least a part of the container holder frame is vertically movable for transferring a storage container between the container holder frame and the conveyor.

23. The container buffering assembly according to claim 22, wherein, when the supports are in the release position, the storage container may pass through the container holder frame vertically.

24. The container buffering assembly according to claim 21, further comprising vertical supports which form the port columns and/or which support the lower ends of the port columns.

25. A method of transferring a storage container from a container lift device to a conveyor using:
a storage system, or
a container buffering assembly,
wherein the method comprises:
lowering a storage container through the port column to the lower end of the port column using a lifting device of the container lift device;
transferring the storage container from the container lift device to the container holder frame by lowering the container lift device with the storage container partially through the container holder frame while the supports are in the release position;
moving the supports to the holding position thereby supporting the storage container;
disconnecting the storage container from the lifting device of the container lift device;
lifting the lifting device away from the container holder frame;
lowering the container holder frame towards the conveyor;
moving the supports to the release position, thereby placing the storage container onto the conveyor.

26. A method of transferring a storage container from a container lift device to a conveyor using:
a storage system comprising a framework structure in which storage containers are stored, a container lift device, and a conveyor, the framework structure comprises at least a first port column through which a storage container may be transferred by the container lift device, the first port column comprises an upper end at which the container lift device is arranged when a storage container is to be lowered or lifted through the port column, and a lower end at which a container buffering assembly is arranged, the container buffering assembly comprises a container holder frame comprising a plurality of supports;
the container holder frame is movable in a first horizontal direction between a first position under the lower end of the first port column and a second position away from the lower end of the first port column;
the supports are actuatable between:
a holding position, in which the supports are configured to support a storage container; and
a release position, in which a storage container may pass through the container holder frame;
wherein at least a part of the container holder frame is vertically movable for transferring a storage container between the container holder frame and the conveyor, or
a container buffering assembly for transferring a storage container between a lower end of a port column and a conveyor, and wherein the container buffering assembly comprises:
rails connectable to the lower end of the port column;
a container holder frame connectable to the rails and comprising a plurality of supports;
the container holder frame is horizontally movable in a first direction between a first position under the lower end of the first port column and a second position away from the lower end of the first port column; wherein the supports are actuatable between:
a holding position, in which the supports are configured to support a storage container, a release position, in which a storage container may pass through the container holder frame;
and wherein at least a part of the container holder frame is vertically movable for transferring a storage container between the container holder frame and the conveyor,
wherein the method comprises:
lowering a storage container through the port column to the lower end of the port column using a lifting device of the container lift device;
transferring the storage container from the container lift device to the container holder frame by lowering the container lift device with the storage container partially through the container holder frame while the supports are in the release position;
moving the supports to the holding position thereby supporting the storage container;
disconnecting the storage container from the lifting device of the container lift device;
lifting the lifting device away from the container holder frame;
lowering the supports towards the conveyor;
moving the supports to the release position, thereby placing the storage container onto the conveyor.

27. A method of transferring a storage container from a conveyor to a container lift device using:
a storage system comprising a framework structure in which storage containers are stored, a container lift device, and a conveyor, the framework structure comprises at least a first port column through which a storage container may be transferred by the container lift device, the first port column comprises an upper end at which the container lift device is arranged when a storage container is to be lowered or lifted through the port column, and a lower end at which a container buffering assembly is arranged, the container buffering assembly comprises a container holder frame comprising a plurality of supports;
the container holder frame is movable in a first horizontal direction between a first position under the lower end of the first port column and a second position away from the lower end of the first port column;
the supports are actuatable between:
a holding position, in which the supports are configured to support a storage container; and
a release position, in which a storage container may pass through the container holder frame;
wherein at least a part of the container holder frame is vertically movable for transferring a storage container between the container holder frame and the conveyor, or
a container buffering assembly for transferring a storage container between a lower end of a port column and a conveyor, and wherein the container buffering assembly comprises:
rails connectable to the lower end of the port column;
a container holder frame connectable to the rails and comprising a plurality of supports;
the container holder frame is horizontally movable in a first direction between a first position under the lower end of the first port column and a second position away from the lower end of the first port column; wherein the supports are actuatable between:
a holding position, in which the supports are configured to support a storage container;
a release position, in which a storage container may pass through the container holder frame;
and wherein at least a part of the container holder frame is vertically movable for transferring a storage container between the container holder frame and the conveyor,
wherein the method comprises:
lowering the container holder frame towards the conveyor into contact with a storage container on the conveyor and moving the supports to the holding position, thereby supporting the storage container;
lifting and horizontally moving the container holder frame to a position at the lower end of the port column;
lowering a lifting device of the container lift device through the port column into contact with the storage container and connecting the lifting device to the storage container;
moving the supports to the release position;
lifting the storage container through the container holder frame and the first port column to the container lift device.

28. The method according to claim 27, wherein the plurality of supports comprises at least a first set of supports and a second set of supports, wherein the first set of supports is arranged in front of the second set of supports, and wherein the first and second set of supports are individually actuatable, and wherein lowering the container holder frame towards the conveyor into contact with a storage container comprises:
actuating the first set of supports and reducing speed of the shuttle relative to speed of the conveyor thereby bringing the first set of supports into connection with the storage container;
when the first set of supports is connected to the storage container, actuating the second set of supports, thereby the container holder frame assumes control of the storage container and the storage container can be retrieved or lifted off the conveyor.

29. A method of transferring a storage container from a conveyor to a container lift device using:
a storage system comprising a framework structure in which storage containers are stored, a container lift device, and a conveyor, the framework structure comprises at least a first port column through which a storage container may be transferred by the container lift device, the first port column comprises an upper end at which the container lift device is arranged when a storage container is to be lowered or lifted through the port column, and a lower end at which a container buffering assembly is arranged, the container buffering assembly comprises a container holder frame comprising a plurality of supports;
the container holder frame is movable in a first horizontal direction between a first position under the lower end of the first port column and a second position away from the lower end of the first port column;
the supports are actuatable between:
a holding position, in which the supports are configured to support a storage container; and
a release position, in which a storage container may pass through the container holder frame:
wherein at least a part of the container holder frame is vertically movable for transferring a storage container between the container holder frame and the conveyor, or
a container buffering assembly for transferring a storage container between a lower end of a port column and a conveyor, and wherein the container buffering assembly comprises:
rails connectable to the lower end of the port column;
a container holder frame connectable to the rails and comprising a plurality of supports;
the container holder frame is horizontally movable in a first direction between a first position under the lower end of the first port column and a second position away from the lower end of the first port column; wherein the supports are actuatable between:
a holding position, in which the supports are configured to support a storage container;
a release position, in which a storage container may pass through the container holder frame;
and wherein at least a part of the container holder frame is vertically movable for transferring a storage container between the container holder frame and the conveyor,
wherein the method comprises:
lowering the supports towards the conveyor into contact with a storage container on the conveyor and moving the supports to the holding position, thereby supporting the storage container;
lifting the supports and horizontally moving the container holder frame to a position at the lower end of the port column;
lowering a lifting device of the container lift device through the port column into contact with the storage container and connecting the lifting device to the storage container;
moving the supports to the release position;
lifting the storage container through the container holder frame and the first port column to the container lift device.
